(19) United States
(12) Patent Application Publication
(10) Pub. No.: US 2005/0127242 A1
(43) Pub. Date: Jun. 16, 2005

(54) Payload dispensing system particularly suited for unmanned aerial vehicles

(76) Inventor: Eugene P. Rivers JR., King George, VA (US)

Correspondence Address: NAVAL SURFACE WARFARE CENTER, DAHLGREN DIVISION;OFFICE OF COUNSEL, CODE XDC1, 17320 DAHLGREN ROAD, DAHLGREN, VA, 22448-5110, US

(21) Appl. No.: 10/729,578

(22) Filed: Nov. 25, 2003

Related U.S. Application Data
(63) Continuation-in-part of application No. 09/922,307, filed on Aug. 1, 2001, now abandoned.
(60) Provisional application No. 60/224,381, filed on Aug. 8, 2000.

(51) Int. Cl. B64D 1/08

(52) U.S. Cl. 244/137.1

(57) ABSTRACT

A payload dispensing system and a method of operation thereof are disclosed that comprises an on-board computer, a magazine, and a controller all of which operatively cooperate so that cartridge actuating devices may be selectively activated so that the contents of the payload being carried by an unmanned aerial vehicle can be accurately delivered to a target of interest.

### STATEMENT OF GOVERNMENT INTEREST

The invention described herein may be manufactured and used by or for the Government of the United States of America for governmental purposes without any payment of any royalty thereon or therefor.

### BACKGROUND OF THE INVENTION

1.0 Field of the Invention

The present invention relates to dispensing systems and, more particularly, to payload dispensing systems particularly suited for use on unmanned aerial vehicles.

2.0 Description of the Related Art

Unmanned aerial vehicles, which includes drones, are pilot-less airplanes controlled from a ground station by the use of RF signals. Unmanned aerial vehicles (UAVs) have many useages, one of which may be the accurate delivery of a payload to a designated site, such as a target of interest.

The accuracy of the delivery of the payload is dependent upon the accuracy at which the payload is dispensed from the UAVs to the target of interest. It is desired that a payload dispensing system be provided that is particularly suited to be mounted on an unmanned aerial vehicle and that allows the payload to be accurately dispensed from the unmanned aerial vehicle.

### OBJECTS OF THE INVENTION

It is a primary object of the present invention to provide a payload dispensing system that accurately dispenses the contents of its payload and that is particularly suited to be mounted on an unmanned aerial vehicle.

It is another object of the present invention to provide for a payload dispensing system that accepts atmospheric data so as to further improve the accuracy at which the payload dispensing system dispenses the contents of its payload.

Another object of the present invention is to provide a payload dispensing system and a method of operation thereof that is easily integrated into unmanned vehicles.

### SUMMARY OF THE INVENTION

This invention is directed to a payload dispensing system particularly suited for being mounted on an unmanned aerial vehicle that communicates with a ground control system. The payload dispensing system comprises a receiver, a transmitter, an autopilot, and a payload dispenser. The receiver receives information from the ground station and provides corresponding output signals. The transmitter transmits information to the ground station and to the autopilot. The autopilot responds to the output signals of the receiver and provides corresponding output signals to the transmitter. The payload dispenser comprises a computer, a magazine, and a controller. The computer comprises at least one input port for receiving the output signals from the receiver and at least one output port. The magazine holds the payload comprising a plurality of tubes, each containing a capsule and each having a cartridge actuating device responsive to an electrical signal. The controller is connected to the at least one output port so as to receive information from the computer and generates corresponding output signals therefrom. The controller has electrical means for being connected to each of the cartridge actuating devices. The controller responds to the information from the computer and generates respective electrical signals to the cartridge actuating devices causing respective capsules to be ejected from the respective tube.

### BRIEF DESCRIPTION OF THE DRAWINGS

A better understanding of the present invention may be realized when considered in view of the following detailed description, taken in conjunction with the accompanying drawings.

FIG. 1 is a simplified drawing of an unmanned aerial vehicle that houses the payload dispensing system of the present invention.

FIG. 2 is a block diagram of one embodiment of the payload dispensing system of the present invention.

FIG. 3 illustrates one embodiment of a payload dispenser of the present invention.

FIG. 4 illustrates another embodiment of the payload dispenser of the present invention.

FIGS. 5A and 5B illustrate a flow chart of one of the operating programs of the present invention running in a ground station.

FIG. 6 illustrates a magazine section that is part of the payload dispenser of the present invention.

FIG. 7 illustrates one tube of the payload dispenser of the present invention.

FIG. 8 illustrates another embodiment of the payload dispensing system of the present invention.

FIG. 9 illustrates a further embodiment of the payload dispensing system of the present invention.

### DETAILED DESCRIPTION OF THE PREFERRED EMBODIMENTS

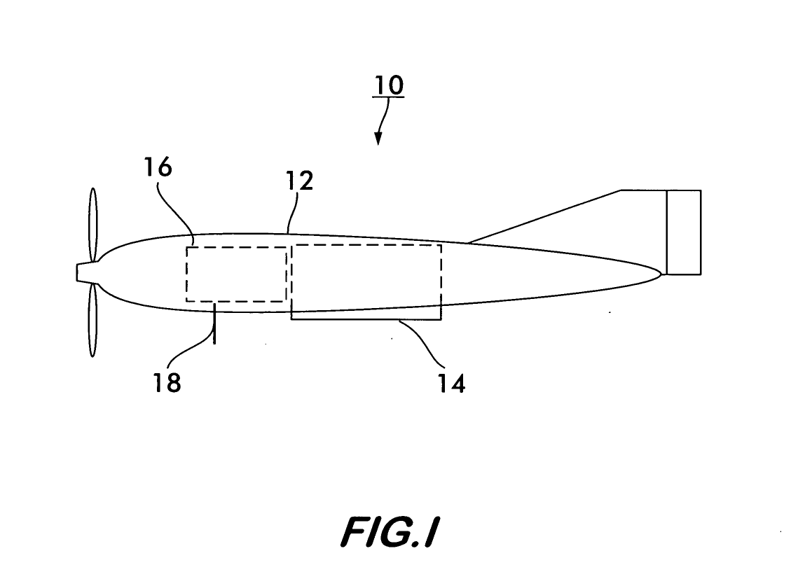

Referring to the drawings, wherein the same reference number indicates the same element throughout, there is shown in FIG. 1 a payload dispensing system 10 that is mounted in a unmanned aerial vehicle 12 shown in a simplified manner. The unmanned aerial vehicle 12 comprises a magazine 14 which may be an ALE-47 type known in the art; payload avionics 16 that includes a dispenser computer, dispenser controller and dispenser data link transceiver each of which may be of a different type dependent on the preferred embodiments to be described; and a transceiver antenna 18.

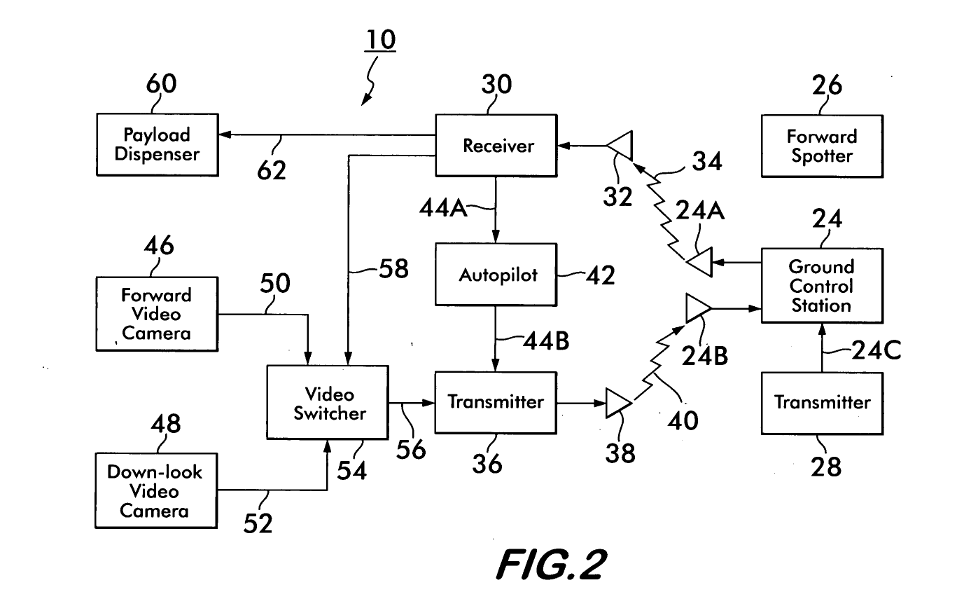

In general, the unmanned aerial vehicle 12 conveys the payload dispensing system 10 to a designated site, such as a target of interest, wherein the payload of the payload dispensing system is released upon command from a ground control station so that the contents of the payload fall from the unmanned aerial vehicle 12 under the influence of gravity. The payload dispensing system 10 provides for the accurate release of the contents of the payload from the unmanned aerial vehicle 12 all of which may be further described with reference to FIG. 2.

The unmanned aerial vehicle 12, which carries the payload dispensing system 10 is controlled by a ground station 24 having transmitting and receiving elements 24A and 24B respectively. In some embodiments, the unmanned aerial vehicle 12 is also controlled from inputs from a forward spotter 26 that routes the related information to the ground control station 24. The ground control station 24 may also receive, via the signal path 24C, information from an associated external transmitter 28.

The payload dispensing system 10 comprises a receiver 30, having a receiving element 32 (provided by the transceiver antenna 18 in FIG. 1), that receives a RF signal from the ground control station 24 by way of RF link 34. The payload dispensing system 10 further comprises a transmitter 36 that transmits information, via its transmitting element 38 (provided by the transceiver antenna 18 in FIG. 1), to the ground control station 24, via element 24B and RF link 40. The payload dispensing system 10 still further comprises an autopilot 42 which receives information from the receiver 30, by way of signal path 44A, and transmits corresponding output signals to transmitter 36, by way of signal path 44B.

The payload dispensing system 10 preferably further comprises first and second video cameras 46 and 48 that respectively provides their output signals, via signal paths 50 and 52, to a video switcher 54. The video switcher 54 transmits information on signal path 56 to transmitter 36 and receives information on signal path 58 from receiver 30.

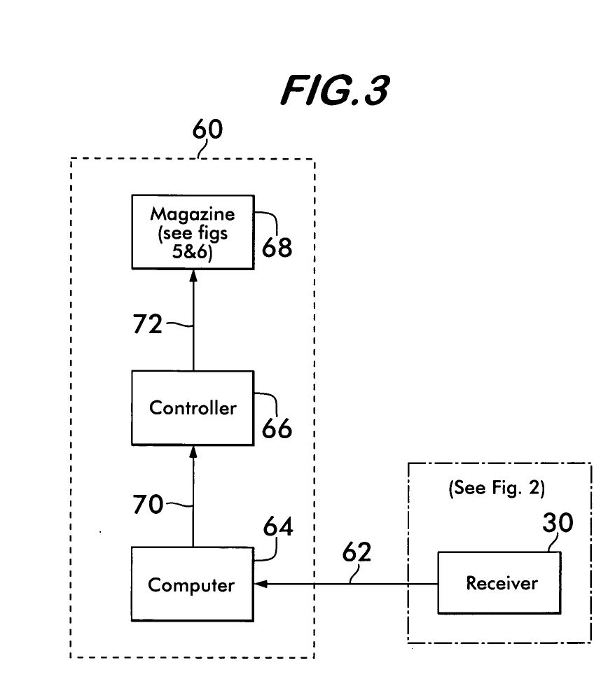

The first camera 46 is preferably mounted on the front end of the unmanned aerial vehicle 12 and serves as a forward video camera, whereas the second video camera 48 is preferably mounted on the unmanned aerial vehicle 12 so as to view downward therefrom and serves as a down-look video camera. The second video camera 48 is used by a system operator utilizing the ground control station 24, as a visual cue for determining when to release the payload contained in a payload dispensing system 10. The video switcher 54 allows the system operator to switch between the forward camera 46, the down-look video camera 48, or a picture-in-a-picture view of both cameras 46 and 48. The payload dispensing system 10 further comprises a payload dispenser 60 that receives information, via signal path 62, from the receiver 30 and may be further described with reference to FIG. 3.

FIG. 3 illustrates the payload dispenser 60 as comprising a computer 64, a controller 66, and a magazine 68. The computer 64 may be a PC104 computer which is known in the art and comprises modular computer components based on Intel processors. The computer 64 has a plurality of input ports, one of which receives output signals from the receiver 30, via signal path 62. The computer 64 further comprises a plurality of output ports one of which is routed to controller 66, via signal path 70.

The controller 66 receives information from the computer 64 and generates corresponding output signals therefrom.

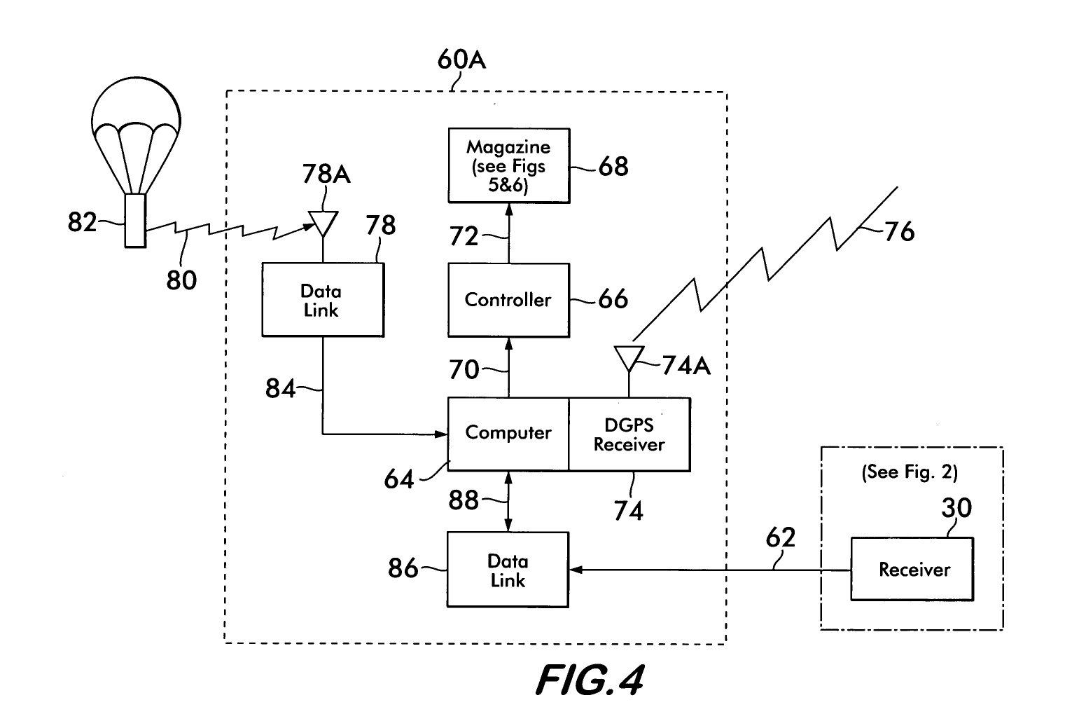

The logic controller 66, in response to the information on signal path 70, operates to send firing pulses to the magazine 68 by way of signal path 72. A further embodiment of a payload dispensing system 60A may be further described with reference to FIG. 4.

The payload dispensing system 60A, in addition to elements of the payload dispensing system 60 of FIG. 3, further comprises the differential GPS (DGPS) receiver 74 having an element 74A which is part of the transceiver antenna 18 (shown in FIG. 1) that receives information from an external source by way of RF link 76. The payload dispensing system 60A further comprises a first data link 78 that receives, via an element 78A of the transceiver antenna 18 (shown in FIG. 1), atmospheric data 80 derived from a sensor 82. The data link 78 routes its output signals to the computer 64 by way of signal path 84.

The payload dispensing system 60A further preferably comprises a data link 86 that receives information from the receiver 30 by way of signal path 62 and routes the received information to the computer 64 by way of bilateral data path 88.

The DGPS receiver 74 is made available by Omni Star and provides precise air vehicle latitude, longitude, altitude, and velocity information to the computer. The computer 64 provides on-board processing to control the DGPS receiver 74. The data link 78 receives atmospheric data that is provided by sensor 82 which is commonly referred to as a T-drop dispenser and which is routed to computer 64. The T-drop data is also routed back to the ground station 24, by way of computer 64, data link 86, receiver 30, and transmitter 36. The ground station 24 utilizes the T-drop data to compute atmospheric conditions, including wind speed and direction from the drop altitude of the unmanned aerial vehicle 12 to the ground.

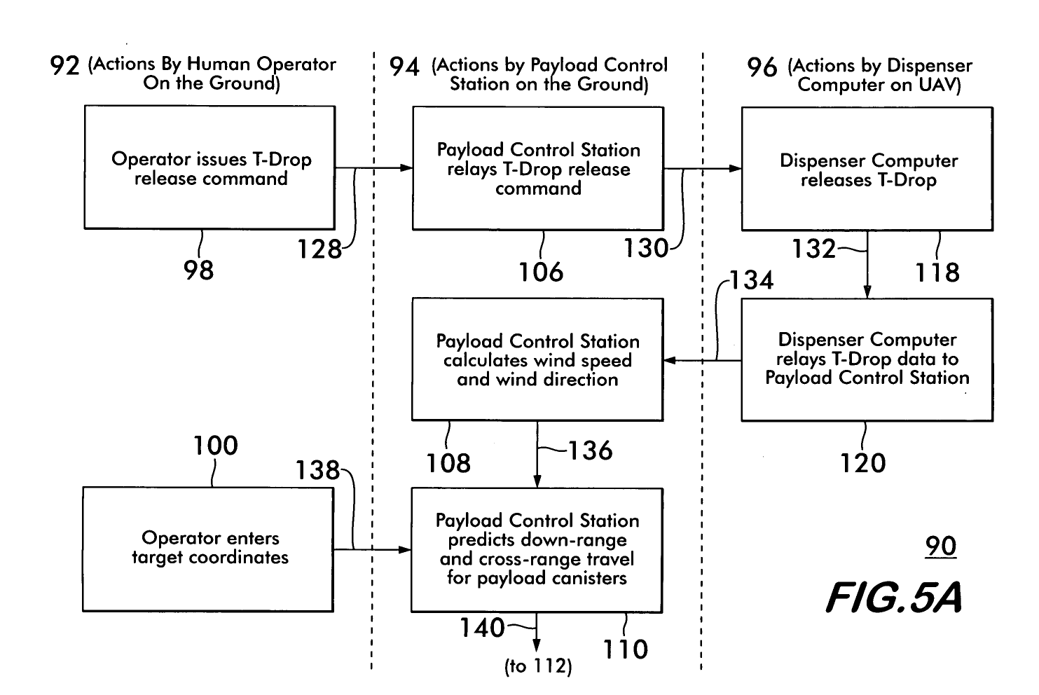

The data link 86 serves as an interface for the computer 64 to communicate to the ground station 24 and allows the ground station 24 to enter target coordinates, and the payload ballistic trajectory model to predict down-range and cross-range travel for the payload contents. The operation of the ground station 24 in response to the entered target coordinates and payload ballistic trajectory model, may be further described with reference to FIG. 5.

FIGS. 5A and 5B illustrate a flow chart 90 of the overall operation of the present invention and is divided in to three columns 92, 94, and 96 that respectively represent the actions by a human operator on the ground; actions by payload control circuit on the ground; and actions by dispenser computer in the unmanned aerial vehicle 12. Each of the three columns 92, 94, and 96 have events that are respectively given in Tables 1, 2 and 3.

TABLE 1
92 (Actions by Human Operator on the Ground)

| Event | Description |
|---|---|
| 98 | Operator issues T-Drop |
| | Release command |
| 100 | Operator enters target |
| | Coordinates |
| 102 | Operator updates UAV |
| | Trajectory based on steering |
| | Commands |
| 104 | Operator issues consent-to- |
| | Fire command |

TABLE 2
94 (Actions by Payload Control Station on the Ground)

| Event | Description |
|---|---|
| 106 | Payload Control Station |
| | relays T-Drop release command |
| 108 | Payload Control Station |
| | calculates wind speed and |
| | wind direction |
| 110 | Payload Control Station |
| | predicts down-range and |
| | cross-range travel for |
| | payload canisters |
| 112 | Payload Control Station sends |
| | target coordinates, and |
| | predicted down-range and |
| | cross-range travel to |
| | Dispenser Computer |
| 114 | Payload Control Station |
| | displays steering commands |
| | and time-to-go to reach |
| | payload release coordinates |
| 116 | Payload Control Station |
| | relays consent-to-fire |
| | command to Dispenser Computer |

TABLE 3
96 (Actions by Dispenser Computer on UAV)

| Event | Description |
|---|---|
| 118 | Dispenser Computer releases |
| | T-Drop |
| 120 | Dispenser Computer relays T- |
| | Drop data to Payload Control |
| | Station |
| 122 | Dispenser Computer computes |
| | payload release coordinates, |
| | steering commands, and time- |
| | to-go until payload release |
| 124 | Dispenser Computer sends |
| | steering commands and time- |
| | to-go to the Payload Control |
| | Station |
| 126 | Dispenser Computer automatically |
| | dispenses payload |
| | when vehicle coordinates are |
| | nearly equal to release |
| | coordinates |

As seen in FIGS. 5A and 5B, the operation is initiated by event 98 in which the operator issues a T-Drop release command that is routed to event 106 by way of signal path 128. Event 106 responds to the release command and generates, via signal path 130, a request to release for the T-Drop to the unmanned aerial vehicle 12 in particular, event 118 which, in turn, sends a signal, via signal path 132, to the event 120, which, in turn, responds, via signal path 134, back to the payload control station, in particular, event 108 thereof, by way of signal path 134. Event 108 supplies a signal, via signal path 136, to the payload control station designated by event 110.

Event 110 also receives, by way of signal path 138, the operator entrance of target coordinates as indicated by event 100. The event 110 responds to the inputs from events 108 and 100 and sends a command, via signal path 140, to event 112 which, in turn, sends a command, via signal path 142 to event 122. The event 122 provides information, to event 124, via signal path 144 and event 124 supplies information, via signal path 146 to event 114.

Event 114 display information to the operator as indicated in the functions shown therein. Event 114 conveys that information to event 102, by way of signal path 148. As shown in event 102, the operator updates the unmanned aerial vehicle 12 trajectory based on steering commands and supplies the updated information to event 104, by way of signal path 150.

Event 104 issues the consent-to-fire command, via signal path 152 to event 116.

Event 116 relays the consent-to-fire command to the dispenser computer, via signal path 154. The dispenser computer, as indicated by event 126, automatically dispenses a payload when the vehicle coordinates are nearly equal to the release coordinates.

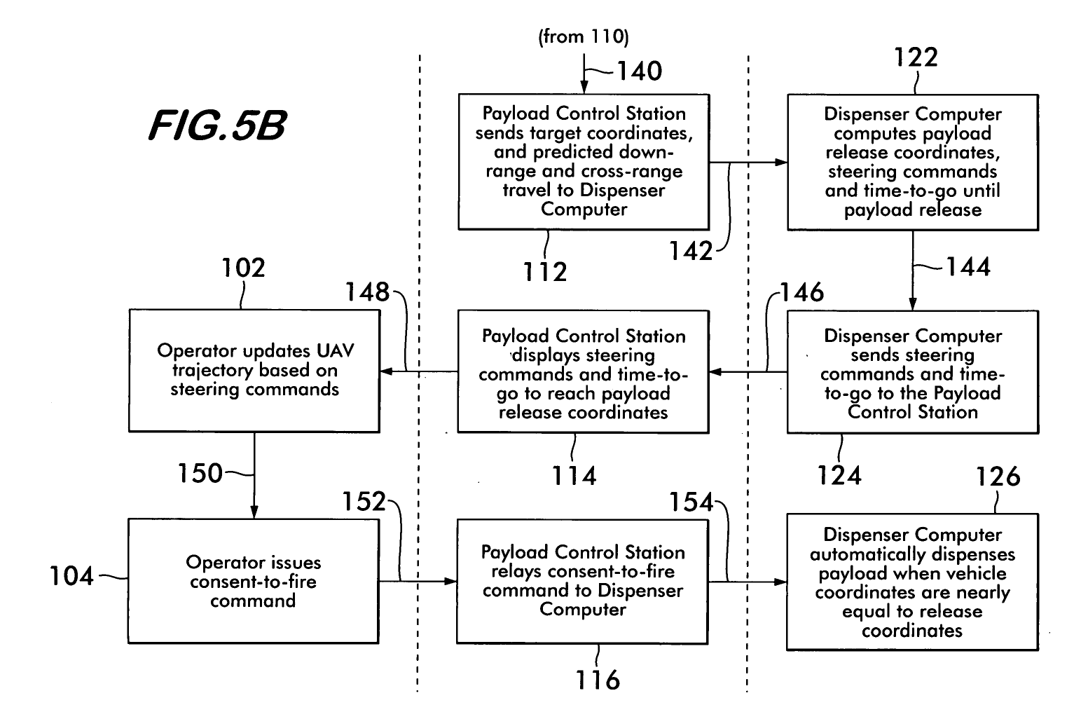

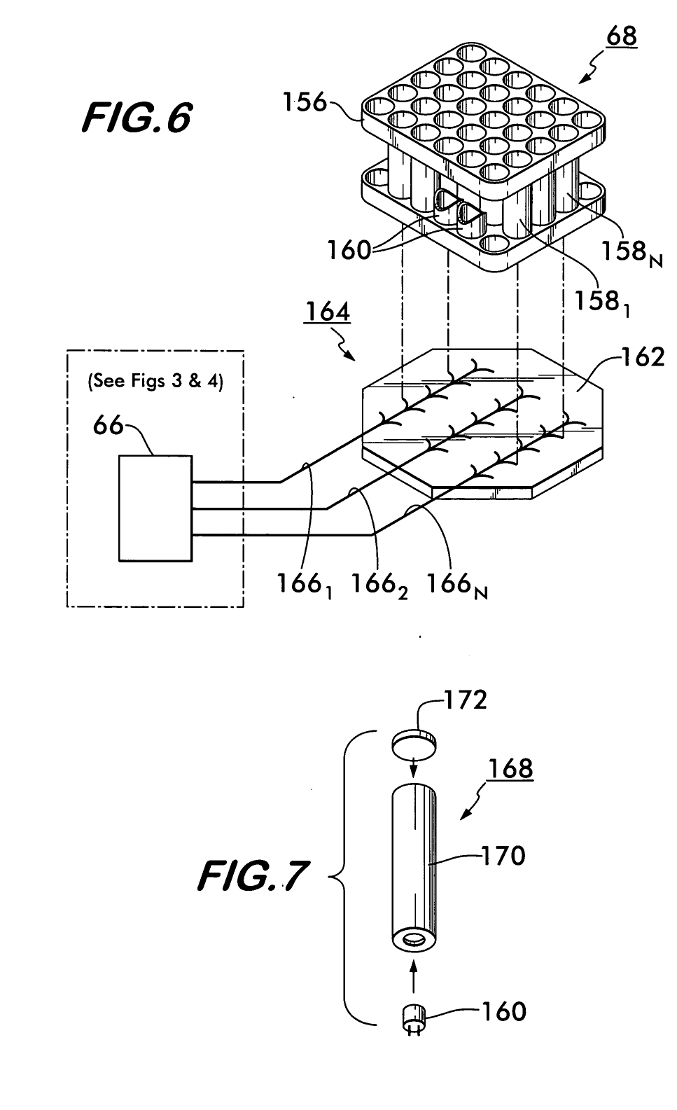

With regard to FIG. 4, the computer 64 calculates steering commands and time-to-go, in a manner known in the art, until the payload release using the information from the on-board differential GPS receiver 74 and sends this data to the ground station 24. The ground station 24, via computer 64, provides a consent-to-fire command when ready and the computer 64, via the controller 66 causes the payload to be dispensed when the on unmanned aerial vehicle 12 reaches the predetermined release coordinates. The controller 66 provides the command signals to a magazine 68, shown in FIGS. 3 and 4, and which may be further described with reference to FIGS. 6 and 7.

The magazine 68 comprises a rack 156 in which is logged a plurality of tubes 158₁ . . . 158_{N} as shown in FIG. 6. FIG. 6 also illustrates two of the tubes 158₁ . . . 158_{N} as being removed, so as to expose the housing of a cartridge actuating device 160. Each of the tubes 158₁ . . . 158_{N} has a cartridge actuating device 160. Each of the cartridge actuating devices 160 is responsive to a respective electrical signal which causes the capsules contained in the tubes 158₁ . . . 158_{N} to be ejected from the respective tube 158₁ . . . 158_{N}. The interconnection between the cartridge actuating devices 160 and the controller 66 is provided by a breech plate 162 having an appropriate wiring harness 164 comprised of multiple paths 166₁, 166₂, . . . 166_{N}. FIG. 6 does not illustrate the capsules that are lodged within the tubes 158₁ . . . 158_{N}, but are shown FIG. 7.

FIG. 7 illustrates a capsule 168 comprised of cylinder 170 having opposite ends, with a cartridge actuating device 160 at one end and a releasable cap 172, preferably comprised of plastic at the other end. The capsules 168 are placed in the tubes 158₁ . . . 158_{N}, in the magazine section 68. The magazine section 68 is preferably mounted in the unmanned aerial vehicle 12 so that the tubes 158₁ . . . 158_{N} are exposed and so that the capsules 168 are ejected from the unmanned aerial vehicle 12 when the controller 66 delivers the electrical signals to the respective cartridge actuating device 160.

It should now be appreciated that the practice of the present invention provides for a payload dispensing system 10 that releases the contents of the payload in response to commands initiated from a ground control system that are accurately delivered to the controller 66 by the computer 64.

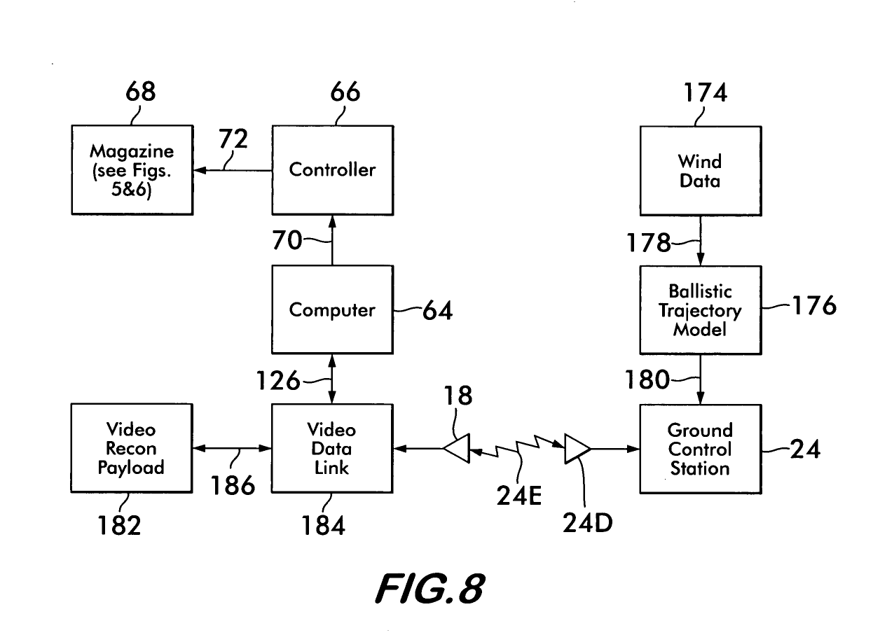

A further embodiment of the present invention may be further described with reference to FIG. 8. The embodiment of the FIG. 8 illustrates the utilization of wind data 174 that is routed to a ballistic trajectory model 176 (similar to that described with reference to FIG. 5), via signal path 178, whereas operating parameters of the ballistic trajectory model 176 are routed to the ground control station 24, via signal path 180. The wind data 174 and the ballistic trajectory model 176 are utilized by the operating program within the ground station 24 to develop the prediction of coordinates for dispensing the payload in order to more accurately designate a point on the ground for the delivery of the payload by the payload dispensing system 10. The operating program includes a simple three (3)-degree of freedom model, known in the art, utilizing the ballistic trajectory model 176 to predict the coordinates at which to dispense the payload based upon atmospheric conditions, and unmanned aerial vehicle 12 velocity, heading, and altitude. The operating program within the ground control station 24 also calculates the depression angle for a video camera, such as the second video camera 48 of FIG. 2, which is included as part of the video reconnaissance payload 182 shown in FIG. 8. The calculations of the depression angle are performed in a manner known in the art. The depression angle information is routed to the video reconnaissance payload 182 by way of transmitter element of transceiver 18, RF link 24E, and receiver element of transceiver 18 of video data link 184. The video data link 184 communicates with the video reconnaissance payload 182 by way of bilateral signal path 186. The video data link 184 also communicates with the computer 64 by way of bilateral signal path 186.

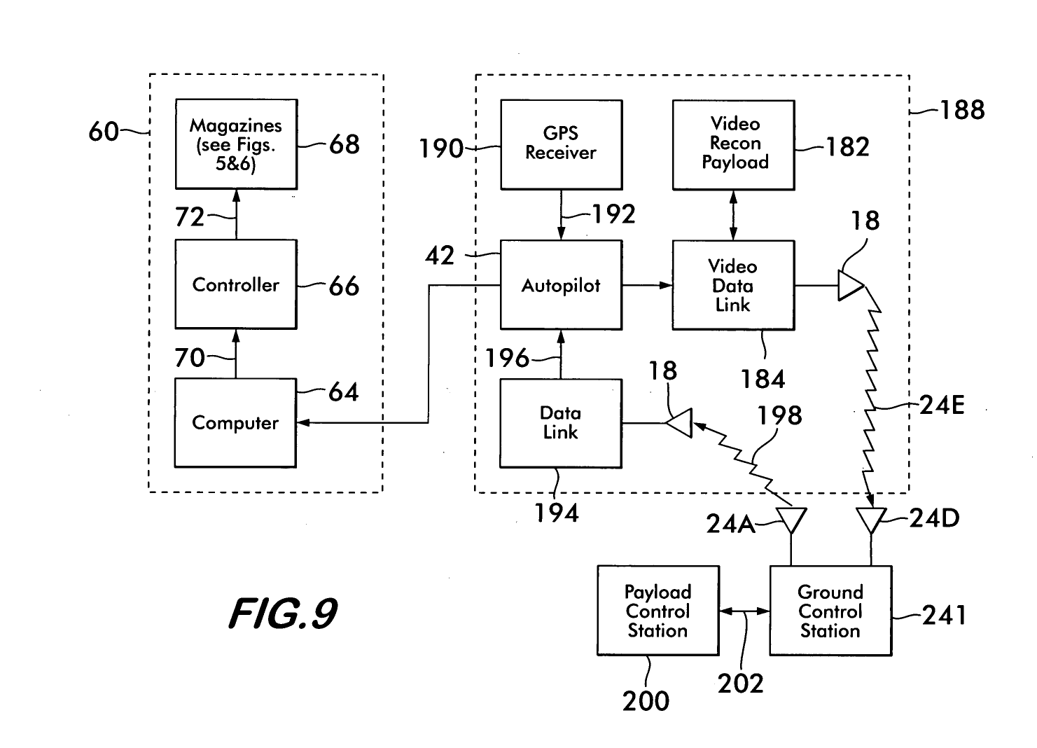

A further embodiment of the present invention may be further described with reference to FIG. 9. FIG. 9 illustrates an embodiment 188 that includes the elements 182 and 184 of FIG. 8, as well as the autopilot 42 of FIG. 2. The embodiment 188 further includes a GPS receiver 190 that supplies location information, via signal path 192 to the autopilot 42. The embodiment 188 further includes the data link 194 that supplies information to the autopilot 42 by way of signal path 196. The data link 194 operatively cooperates with a receiver element of transceiver 18 that receives information from the transmitting element 24A of the ground control system 24 by way of RF link 198.

The embodiment 188 further comprises the utilization of payload control information which is routed to the ground control station 24 by way of signal path 202. The ground control station 24, in a manner similar to that described with reference to FIG. 8, has an operating program that provides for payload ballistic trajectory model, but having a more accurate 6-degree-of-freedom payload ballistic trajectory model (known in the art) which, in turn, improves the accuracy of the payload dispensing system 10 which, in turn, allows for the payload carried by the unmanned aerial vehicle 12 to be more accurately delivered to its target of interest.

It should now be appreciated that the practice of the present invention provides for various embodiments each allowing for the accurate release of the contents of the payload being carried by the unmanned aerial vehicle 12.

While the invention has been described with reference to the specific embodiments, this description is illustrative and is not to be construed as limited in scope of the invention. Various modifications will occur to those skilled in the art without departing from the spirit and scope of the invention as defined by the appending claims.

1. A payload dispensing system particularly suited for being mounted on an unmanned aerial vehicle that communicates with a ground control station, said system comprising:
a receiver for receiving information from said ground control station and providing corresponding output signals;
a transmitter for transmitting information to said ground control station;
an autopilot responsive to the output signals of said receiver and providing corresponding output signals to said transmitter;
a payload dispenser comprising:
a computer having at least one port for receiving output signals from said receiver and at least one output port;
a magazine holding said payload comprising a plurality of tubes each containing a capsule and each having a cartridge actuating device, said capsule being dimensioned so that said cartridge actuating device is at least partially insertable into said capsule, each of said cartridge actuating device being responsive to a respective electrical signal; and
a controller connected to said at least one output port so as to receive information from said computer and generating corresponding output signals therefrom, said controller having electrical means for being connected to each of said cartridge actuating devices, said controller in response to said information from said computer generating respective electrical signals to respective said cartridge actuating devices causing respective capsules to be ejected from said respective tube.

2. The system according to claim 1 further comprising a first video camera mounted on the front of said unmanned aerial vehicle and providing output signals that are routed to said autopilot.

3. The system according to claim 2 further comprising a second video camera mounted on said unmanned aerial vehicle so as to view downward and providing output signals that are routed to said autopilot.

4. The system according to claim 3 further a video switcher interposed between said first and second video cameras and said transmitter, said video switcher being connected to receive and respond to said output signals of said receiver.

5. The system according to claim 1, wherein said unmanned aerial vehicle has a bomb bay with an opening and said magazine is mounted in said bomb bay with said tubes being exposed in said opening so that said capsules are ejected from said opening.

6. The system according to claim 1, wherein said electrical means for connecting said controller to each of said cartridge actuating devices comprises a breech plate having an appropriate wiring harness.

7. The system according to claim 1, wherein each of said tubes has opposite ends with said cartridge activating device at one end and a releasable cap at the other end.

8. The system according to claim 7, wherein said releasable cap is plastic.

9. The system according to claim 1, wherein said payload dispenser system further comprises a differential GPS receiver providing output signals to an input port of said computer.

10. The system according to claim 1, wherein said payload dispenser system further comprises a first data link receiving atmospheric data and providing output signals to an input port of said computer.

11. The system according to claim 1, wherein said payload dispenser system further comprises a second data link interposed between said computer and said receiver and receiving output signals from said receiver representative of payload data link and providing output signals to an input port of said computer and receiving output signals from an output port of said computer.

12. A method of providing a payload dispensing system particularly suited for being mounted on an unmanned aerial vehicle that communicates with a ground control station, said method comprising:
providing a receiver for receiving information from said ground control station and providing corresponding output signals;
providing a transmitter for transmitting information to said ground control station;
providing an autopilot responsive to the output signals of said receiver and providing corresponding output signals to said transmitter;
providing a payload dispenser comprising:
a computer having at least one input port for receiving output signals from said receiver and at least one output port;
providing a magazine holding said payload comprising a plurality of tubes each containing a capsule and each having a cartridge actuating device, said capsule being dimensioned so that said cartridge actuating device is at least partially insertable into said capsule, each of said cartridge actuating device being responsive to an a respective electrical signal; and
providing a controller connected to said at least one output port so as to receive information from said computer and generating corresponding output Attorney Docket No. 95857 signals therefrom, said provided controller having electrical means for being connected to each of said cartridge actuating devices, said controller in response to said information from said computer generating respective electrical signals to respective said cartridge actuating devices causing respective capsules to be ejected from said respective tube.

13. The method according to claim 12, further comprising providing a first video camera mounted on the front of said unmanned aerial vehicle and providing output signals that are routed to said autopilot.

14. The method according to claim 13, further comprising providing a second video camera mounted on said unmanned aerial vehicle so as to view downward and providing output signals that are routed to said autopilot.

15. The method according to claim 14, further comprising providing a video switcher interposed between said first and second video cameras and said transmitter, said video switcher being connected to receive and respond to said output signals of said receiver.

16. The method according to claim 12, wherein said unmanned aerial vehicle has a bomb bay with an opening and said magazine is mounted in said bomb bay with said tubes being arranged so as to be exposed in said opening so that said capsules are ejected from said opening.

17. The method according to claim 12, wherein said provided electrical means for connecting said controller to each of said cartridge actuating devices comprises a breech plate having an appropriate wiring harness.

18. The method according to claim 12, wherein each of said provided tubes has opposite ends with said cartridge actuating device being placed at one end and a releasable cap being placed at the other end.

19. The method according to claim 18, wherein said releasable cap is plastic.

20. The method according to claim 12, wherein said payload dispenser system further comprises a differential GPS receiver providing output signals to an input port of said computer.

21. The method according to claim 12, wherein said payload dispenser system further comprises a first data link receiving atmospheric data and providing output signals to an input port of said computer.

22. The method according to claim 12, wherein said payload dispenser system further comprises a second data link interposed between said computer and said receiver and receiving output signals from said receiver representative of payload data link and providing output signals to an input port of said computer and receiving output signals from an output port of said computer.

23. A payload dispenser particularly suited for being mounted on an unmanned aerial vehicle that communicates with a ground control station, said payload dispenser comprising:
a computer having at least one input port for receiving output signals from said receiver and at least one output port;
a magazine holding said payload comprising a plurality of tubes each containing a capsule and each having a cartridge actuating device, said capsule being dimensioned so that said cartridge actuating device is at least partially insertable into said capsule, each of said cartridge actuating device being responsive to an a respective electrical signal; and
a controller connected to said at least one output port so as to receive information from said computer and generating corresponding output signals therefrom, said controller having electrical means for being connected to each of said cartridge actuating devices, said controller in response to said information from said computer generating respective electrical signals to respective said cartridge actuating device causing respective capsules to be ejected from said respective tube.

24. The payload dispenser according to claim 23, wherein said unmanned aerial vehicle has a bomb bay with an opening and said magazine is mounted in said bomb bay with said tubes so as to be exposed in said opening so that said capsules are ejected from said opening.

25. The payload dispenser according to claim 23, wherein said electrical means for connecting said controller to each of said cartridge actuating devices comprises a breech plate having appropriate wiring harness.

26. The payload dispenser according to claim 23, wherein each of said tubes has opposite ends with said cartridge activating device at one end and a releasable cap at the other end.

27. The payload dispenser according to claim 26, wherein said releasable cap is plastic.

28. The payload dispenser according to claim 23, further comprises a differential GPS receiver providing output signals to an input port of said computer.

29. The payload dispenser according to claim 23, further comprises a first data link receiving atmospheric data and providing output signals to an input port of said computer.

30. The payload dispenser according to claim 23, further comprises a second data link interposed between said computer and said receiver and receiving output signals from said receiver representative of payload data link and providing output signals to an input port of said computer and receiving output signals from an output port of said computer.
